(19) United States
(12) Patent Application Publication
(10) Pub. No.: US 2010/0124152 A1
(43) Pub. Date: May 20, 2010

(54) Image Clock

(76) Inventor: Gilbert Kye Lee, Monterey Park, CA (US)

Correspondence Address: PARK LAW FIRM, 3255 WILSHIRE BLVD, SUITE 1110, LOS ANGELES, CA, 90010, US

(21) Appl. No.: 12/273,499

(22) Filed: Nov. 18, 2008

(51) Int. Cl. G04B 19/06

(52) U.S. Cl. 368/232

(57) ABSTRACT

An image clock includes dials, hands, first images, second images, a background, and a controller. The dials are disposed in a pattern configured for indicating numbers. The hands are configured for indicating time with the dials. The hands comprise symbols, geometrical shapes, and colors, and the shape and the color of the hands is controllable. The first images are provided around the plurality of dials. The second images are provided in central regions surrounded by the dials. The symbols, shapes, and the colors of the first and second images are controllable. The background comprises occupied and unoccupied portions, and the dials, the hands, the first and second images are disposed on the plurality of occupied portions of the background. The controller is configured for controlling the symbols, the shapes, and the colors of the dials, the hands, the images, and the background. The background comprises displaying devices.

### BACKGROUND OF THE INVENTION

The present invention relates to a image clock. More particularly, this invention relates to a image clock, which extends the usage time of a personal digital assistant with more electrical power provided in a charging portion of the image clock.

Clocks have had hands and dials. For the most of the time, clocks had hands or pendulum bob which are powered and move mechanically.

These days, almost everything is digital. Mechanical movement has been curtailed much using the digital technology. Digital clock or watch are so prevalent that sometimes it is hard to find a clock having moving hands.

However, people change very slowly. Even with all the nice and precise digital watches, some of them want to look at a “regular” looking color, which has dials and hands.

Accordingly, a need for an image clock has been present for a long time. This invention is directed to solve these problems and satisfy the long-felt need.

### SUMMARY OF THE INVENTION

The present invention contrives to solve the disadvantages of the prior art.

An objective of the invention is to provide an image clock displaying time in various formats.

Another object of the invention is to provide an image clock, which can display time in formats changing with time or under conditions.

Still another object of the invention is to provide an image clock, which enhances reading time by adjusting the display design.

An aspect of the invention provides an image clock.

The image clock comprises a plurality of dials, a plurality of hands, a plurality of first images, a plurality of second images, a background, and a controller.

The plurality of dials are disposed in a pattern configured for indicating numbers, and the dials comprises a plurality of numbers, numerals, and symbols, and wherein the pattern are controllable.

The plurality of hands are configured for indicating time with the plurality of dials, and the hands comprises symbols, geometrical shapes, and colors, and wherein the shape and the color of the hands are controllable.

The plurality of first images are provided around the plurality of dials, and the first images comprises symbols, shapes, and colors. The symbols, shapes, and the colors of the first images are controllable.

The plurality of second images are provided in central regions surrounded by the plurality of dials, and the second images are comprises symbols, shapes, and colors. The symbols, shapes, and the colors of the second images are controllable;

The background comprises a plurality of occupied portions and unoccupied portions, and the dials, the hands, the first and second images are disposed on the plurality of occupied portions of the background. The unoccupied portions comprise shapes and colors.

The controller is configured for controlling the symbols, the shapes, and the colors of the dials, the hands, the first and second images, and the background.

The background comprises one or more displaying devices. In fact, therefore, all the other components are displayed on the background as images.

The background may be circular in shape. The pattern of the plurality of dials may comprise a circle.

The plurality of hands may comprise an hour hand and a minute hand. The plurality of hands may further comprise a second hand.

The hour hand and minute hand may have a same color. Alternatively, the hour hand and the minute hand may have different colors. Also, the hour and minute hands may have different shapes or similar shapes.

The plurality of hands may comprise a common center and revolve axially against the plurality of dials.

The first images may be configured to make a portion of a corresponding one of the plurality of dials represented in a reverse image. The first images may comprise a concentric circular band covering the plurality of dials. A subset of the first images may be darkened, and hours represented by the subset of the first images may correspond to nighttime of a day. The subset of the dials may be reversed in color or tone.

The controller may determine the nighttime using a date of year.

The second images may comprise symbols, shapes, and colors of different countries. The second images may be disposed by the dials corresponding to local times of the countries.

The second images may comprise national flags. The second images may further comprise two different shades overlapped on the flags, and the shades may indicate days and nights of the countries.

The brightness of the unoccupied portions of the background may be controllable.

The dials may comprise numerals from one to twelve.

The dials may comprise numerals from one to twenty four.

In certain embodiment of the invention, the period of alarm time may be highlighted on corresponding dials, the occupied portions, and the unoccupied portions, and the highlighted portion may be flashing when it is the alarm time.

The advantages of the present invention are: (1) the image clock allows a user to choose design of the clock display; and (2) the image clock facilitates reading of the time by changing the display format according to a predetermined schedule.

Although the present invention is briefly summarized, the fuller understanding of the invention can be obtained by the following drawings, detailed description and appended claims.

### BRIEF DESCRIPTION OF THE DRAWINGS

These and other features, aspects and advantages of the present invention will become better understood with reference to the accompanying drawings, wherein:

FIG. 1 is a schematic diagram showing an image clock according to an embodiment of the present invention;

FIG. 2 is a front plan view of an image clock having second images according to an embodiment of the present invention;

FIG. 3 is another front plan view of the image clock having first and second images of FIG. 2; and

FIG. 4 is a partial view of dials of the image clock of FIG. 3 according to an embodiment of the invention.

### DETAILED DESCRIPTION EMBODIMENTS OF THE INVENTION

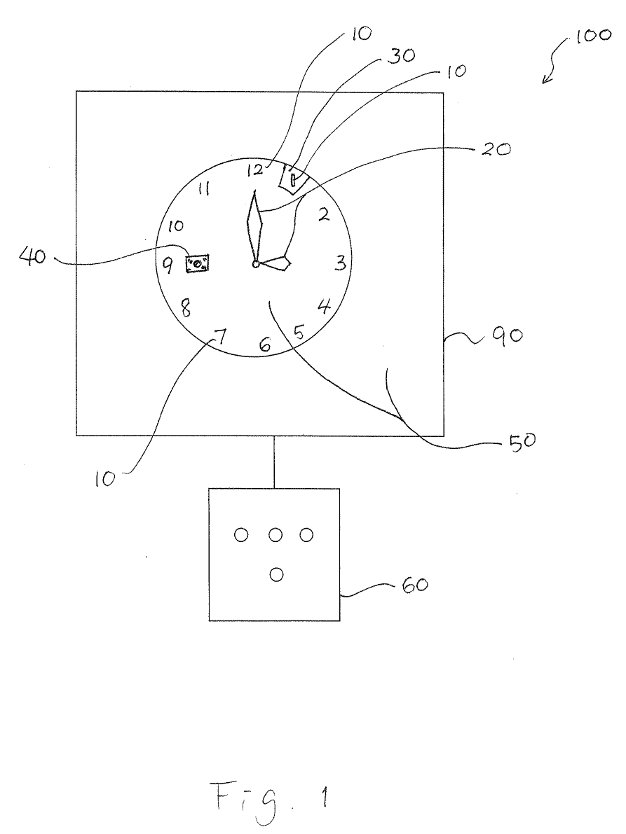

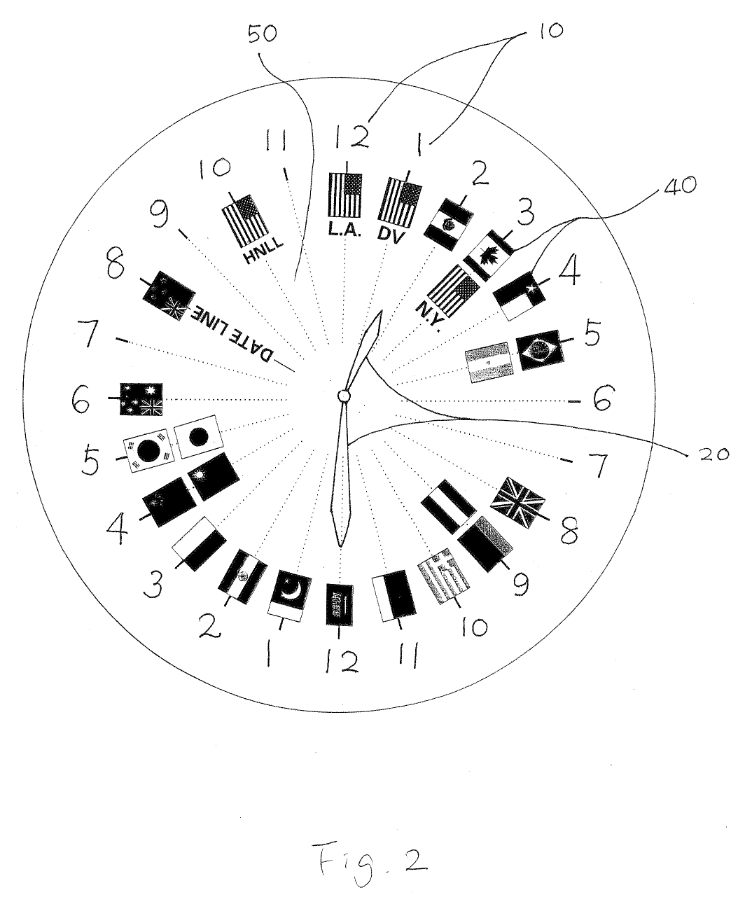

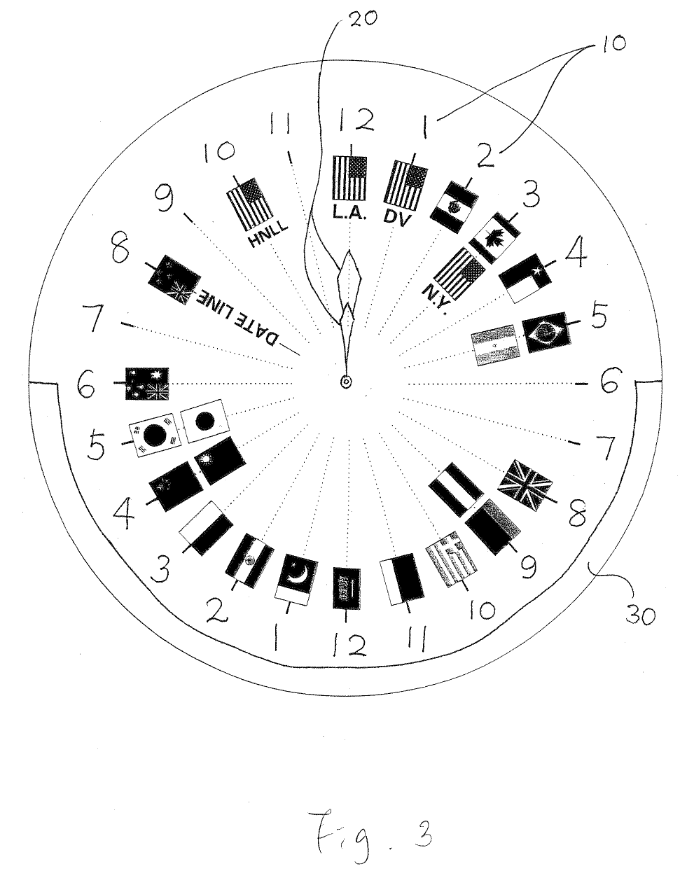

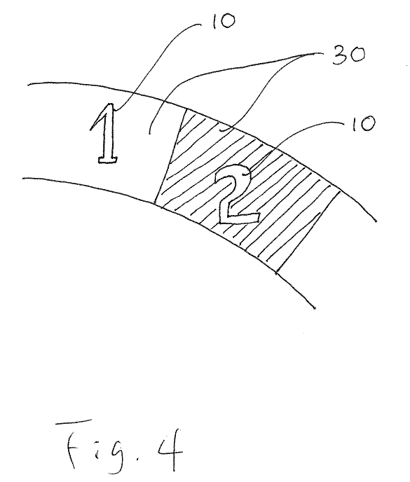

FIG. 1 is a schematic diagram showing an image clock 100 according to an embodiment of the present invention. FIG. 2 is a front plan view of an image clock 100 having second images according to an embodiment of the present invention, and FIG. 3 shows another front plan view of the image clock 100 of FIG. 2.

In an aspect of the invention, the image clock 100 is provided on a display 90. Unlike a physical traditional clock which has physical and mechanical dials and hands, the image clock 100 does not have things like plastic or stainless dials or steel hands, but the image clock 100 according to the invention is displayed on a display 90 as shown in FIG. 1. Since the parts of the clock are just images on the display 90, the shapes or colors of the parts can be easily changed or controlled through the display 90.

The image clock 100 comprises a plurality of dials 10, a plurality of hands 20, a plurality of first images 30, a plurality of second images 40, a background 50, and a controller 60.

The plurality of dials 10 are disposed in a pattern configured for indicating numbers, and the dials 10 comprise a plurality of numbers, numerals, and symbols. The pattern is controllable. The dials 10 may stand for or be translated into hour, minute, and second in time. The dials 10 may include Arabic numbers, Roman numbers, or any other symbols indicating numbers.

The plurality of hands 20 are configured for indicating time with the plurality of dials 10, and the hands 20 comprises symbols, geometrical shapes, and colors, and wherein the shape and the color of the hands 20 are controllable and may be controlled to change with time or date. For example, the color of the hands 20 may be bright red on Sundays as usually seen at a calendar.

The plurality of first images 30 are provided around or along the plurality of dials 10, and the first images 30 comprises symbols, shapes, and colors. The symbols, shapes, and the colors of the first images 30 are controllable.

The plurality of second images 40 are provided in central regions surrounded by the plurality of dials 10, and the second images 40 are comprises symbols, shapes, and colors. The symbols, shapes, and the colors of the second images 40 are controllable.

The background 50 comprises a plurality of occupied portions and unoccupied portions, and the dials 10, the hands 20, the first and second images 30, 40 are disposed on the plurality of occupied portions of the background 50. The unoccupied portions comprise shapes and colors. In the illustrated embodiment in FIGS. 2 and 3, the empty space in the middle of the image clock 100 is the unoccupied portions. Also, the background 50 may be a screen of a display 90 as in FIG. 1.

The controller 60 is configured for controlling the symbols, the shapes, and the colors of the dials 10, the hands 20, the first and second images 30, 40, and the background 60. In certain embodiments of the invention, the controller 60 may include a central processing unit, a memory and other computing device for controlling the display 90. The display 90 can have any shape, for example, rectangular in FIG. 1, but not limited to it. As in FIGS. 2 and 3, the display 90 itself may be circular.

The background 50 comprises one or more displaying devices. In fact, therefore, all the other components are displayed on the background as images. The displaying devices may comprise a LCD, a CRT, a Plasma display, and many others.

The background 50 may be circular in shape in FIGS. 2 and 3. In such illustrated embodiments of the invention, the pattern of the plurality of dials 10 may comprise a circle.

The plurality of hands 20 may comprise an hour hand and a minute hand. The plurality of hands 20 may further comprise a second hand.

The hour hand and minute hand may have a same color. Alternatively, the hour hand and the minute hand may have different colors. Also, the hour and minute hands may have different shapes or similar shapes.

The plurality of hands 20 may comprise a common center and revolve axially against the plurality of dials 10.

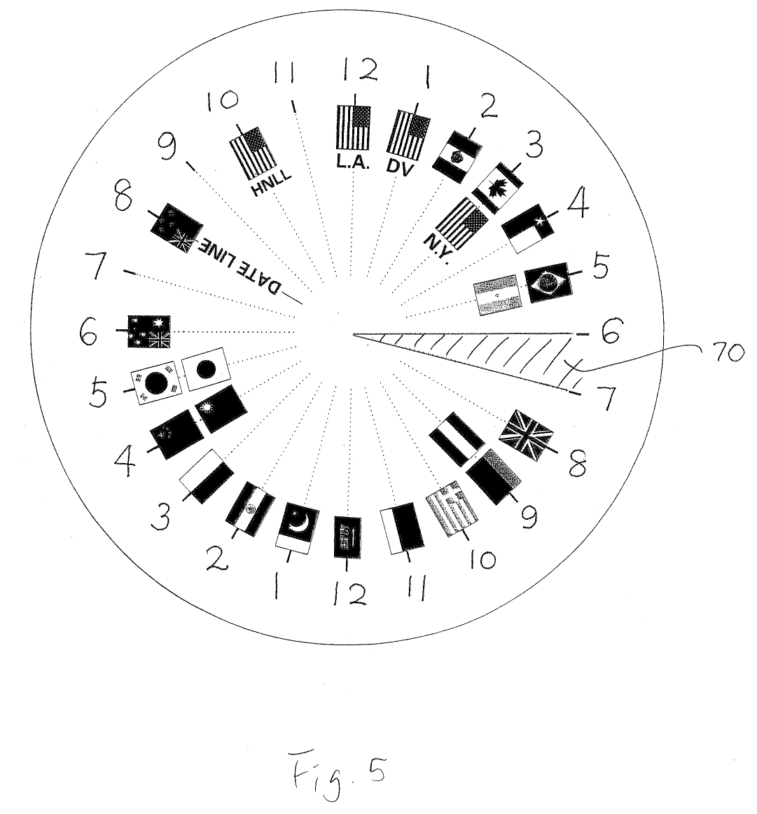

The first images 30 may be configured to make a portion of a corresponding one of the plurality of dials 10 represented in a reverse image. The first images 30 may comprise a concentric circular band surrounding as in FIG. 3 or covering the plurality of dials 10 as in FIG. 4. A subset of the first images 30 may be darkened, and hours represented by the subset of the first images 30 may correspond to nighttime of a day. The subset of the dials 10 may be reversed in color or tone.

The controller 60 may determine the nighttime using a date of year.

The second images 40 may comprise symbols, shapes, and colors of different countries. The second images 40 may be disposed by the dials 10 corresponding to local times of the countries.

The second images 40 may comprise national flags. The second images 40 may further comprise two different shades overlapped on the flags, and the shades may indicate days and nights of the countries.

The brightness of the unoccupied portions of the background 50 may be controllable. Thereby, the unoccupied portions may be used as a night light.

The dials 10 may comprise numerals from one to twelve as in a regular clock.

Alternatively, the dials may comprise numerals from one to twenty four. Then, the day and night of a day can be fully displayed on the clock.

In certain embodiments of the invention, the image clock 100 may display a period time in a different color. For example, an alarm can be set visually. The dials 10 and corresponding unoccupied portions of the background can be highlighted.

In certain embodiment of the invention, the period of alarm time may be highlighted on corresponding dials, the occupied portions, and the unoccupied portions as shown in FIG. 5. The highlighted portion 70 may be flashing when it is the alarm time.

While the invention has been shown and described with reference to different embodiments thereof, it will be appreciated by those skilled in the art that variations in form, detail, compositions and operation may be made without departing from the spirit and scope of the invention as defined by the accompanying claims.

What is claimed is:

1. An image clock comprising:
a plurality of dials disposed in a pattern configured for indicating numbers, wherein the dials comprises a plurality of numbers, numerals, and symbols, and wherein the pattern is controllable;
a plurality of hands configured for indicating time with the plurality of dials, wherein the hands comprises symbols, geometrical shapes, and colors, and wherein the shape and the color of the hands is controllable;
a plurality of first images provided around the plurality of dials, wherein the first images comprises symbols, shapes, and colors, and wherein the symbols, shapes, and the colors of the first images is controllable;
a plurality of second images provided in central regions surrounded by the plurality of dials, wherein the second images are comprises symbols, shapes, and colors, and wherein the symbols, shapes, and the colors of the second images are controllable;
a background comprising a plurality of occupied portions and unoccupied portions, wherein the dials, the hands, the first and second images are disposed on the plurality of occupied portions of the background, wherein the unoccupied portions comprise shapes and colors; and
a controller configured for controlling the symbols, the shapes, and the colors of the dials, the hands, the first and second images, and the background,
wherein the background comprises one or more displaying devices.

2. The image clock of claim 1, wherein a period of alarm time is highlighted on corresponding dials, the occupied portions, and the unoccupied portions, and wherein the highlighted portion is flashing when it is the alarm time.

3. The image clock of claim 1, wherein the background is circular in shape, and wherein the pattern of the plurality of dials comprises a circle.

4. The image clock of claim 3, wherein the plurality of hands comprise an hour hand and a minute hand.

5. The image clock of claim 4, wherein the plurality of hands further comprise a second hand.

6. The image clock of claim 4, wherein the hour hand and minute hand have a same color.

7. The image clock of claim 4, wherein the hour hand and the minute hand have different colors.

8. The image clock of claim 4, wherein the plurality of hands comprise a common center and revolve axially against the plurality of dials.

9. The image clock of claim 3, wherein the first images are configured to make a portion of a corresponding one of the plurality of dials represented in a reverse image.

10. The image clock of claim 9, wherein the first images comprise a concentric circular band covering the plurality of dials.

11. The image clock of claim 10, wherein a subset of the first images are darkened, and wherein hours represented by the subset of the first images correspond to nighttime of a day.

12. The image clock of claim 11, wherein a subset of the dials are reversed in color or tone.

13. The image clock of claim 12, wherein the controller determines the nighttime using a date of year.

14. The image clock of claim 1, wherein the second images comprise symbols, shapes, and colors of different countries.

15. The image clock of claim 14, wherein the second images are disposed by the dials corresponding to local times of the countries.

16. The image clock of claim 14, wherein the second images comprises national flags.

17. The image clock of claim 16, wherein the second images further comprise two different shades overlapped on the flags, and wherein the shades indicate days and nights of the countries.

18. The image clock of claim 1, wherein a brightness of the unoccupied portions of the background is controllable.

19. The image clock of claim 1, wherein the dials comprise numerals from one to twelve.

20. The image clock of claim 1, wherein the dials comprise numerals from one to twenty four.
